(19) United States
(12) Patent Application Publication
(10) Pub. No.: US 2011/0239109 A1
(43) Pub. Date: Sep. 29, 2011

(54) METHODS AND APPARATUS TO DISPLAY PROCESS DATA

(76) Inventors: MARK NIXON, Round Rock, TX (US); Lee Allen Neitzel, Austin, TX (US)

(21) Appl. No.: 12/891,121

(22) Filed: Sep. 27, 2010

Related U.S. Application Data
(63) Continuation-in-part of application No. 12/730,895, filed on Mar. 24, 2010.

(51) Int. Cl. G06F 3/14

(52) U.S. Cl. 715/236

(57) ABSTRACT

Example methods and apparatus to display process data are disclosed. A disclosed example method includes receiving a request to view process data via a web browser, identifying a server that stores the process data, wherein the server receives the process data from a process control system, retrieving the process data from the server, selecting an Extensible Stylesheet Language Transformation (XSLT) template based on a property of the process data, and generating a display file conforming to a web browsing format based on the XSLT template, the property, and the process data, wherein the display file specifies how the process data is to be displayed via the web browser.

### RELATED APPLICATION

This application is a continuation-in-part of U.S. patent application Ser. No. 12/730,895, filed Mar. 24, 2010, the entirety of which is incorporated by reference.

### FIELD OF THE DISCLOSURE

The present disclosure relates generally to process control systems and, more particularly, to methods and apparatus to display process data.

### BACKGROUND

Data systems such as control systems, manufacturing automation systems, and other industrial systems like those used in chemical, petroleum or other processes, may store data on a server to allow authorized users to access the data from any location. Typically, the data may be stored on servers that conform to an interoperability data packing format such as, for example, the OPC. The OPC is a set of standards that define protocol-based interfaces for severs providing access to industrial process data, automation data, manufacturing data, and/or batch data.

Currently, clients may connect to a server associated with an interoperability data packing format by creating an application that is specific to the server or a type of data stored on the server. For example, an application may be written as an executable program in a procedural programming language that conforms to a specific operating platform and conforms to a communication protocol of a corresponding interoperability data packing format employed by a server. The application may be created by a server vendor or a client vendor that configures the application specifically for the particular server. In examples where a client may need to access data stored on multiple servers, a separate application may need to be created for each server to conform to the specific interface requirements of the servers. Further, each of these applications may need to be modified if the data stored on the corresponding server is migrated to another server and/or if the interface requirements of the server are changed.

### SUMMARY

Example methods and apparatus to display process data are described. In one example, a method includes receiving a request to view process data via a web browser and identifying a server that stores the process data, wherein the server receives the process data from a process control system. The example method also includes retrieving the process data from the server and selecting an Extensible Stylesheet Language Transformation (XSLT) template based on a property of the process data. The example method further includes generating a display file conforming to a web browsing format based on the XSLT template, the property, and the process data, wherein the display file specifies how the process data is to be displayed via the web browser.

An example apparatus includes an adaptor to identify a server that stores requested process data, wherein the server receives the process data from a process control system. The example adaptor is to also access the process data from the server. The example apparatus also includes a data processor to select a template based on a property of the process data. The example apparatus further includes a web-based interface to generate a display file conforming to a web browsing format based on the template, the property, and the process data, wherein the display file specifies how the process data is to be displayed via a client application.

### BRIEF DESCRIPTION OF THE DRAWINGS

FIG. 1 is a block diagram illustrating a control environment with an example control system communicatively coupled to an external server that is accessible by a client via a webpage server that includes a wrapper.

FIG. 2 is a functional diagram of the example wrapper of FIG. 1.

FIG. 3 is a block diagram of an example service-orientated framework that may be used to implement the example wrapper of FIGS. 1 and 2.

FIG. 4 shows an example interface for server identification process data displayed in a web browser.

FIG. 5 shows an example interface for process data displayed in a web browser.

FIG. 6 shows an example interface communicating with the example wrapper of FIGS. 1 and/or 2 to display process data in a web browser.

FIGS. 7A and 7B show an example interface displayed on a wireless device communicating with the example wrapper FIGS. 1 and/or 2 to display process data in a client application.

FIG. 8 shows an example interface displaying process data in a web browser.

FIGS. 9A-9C are flowcharts of an example method that may be used to implement the example wrapper of FIGS. 1 and/or 2.

FIG. 10 is a block diagram of an example processor system that may be used to implement the example methods and apparatus described herein.

### DETAILED DESCRIPTION

Although the following describes example methods and apparatus including, among other components, software and/or firmware executed on hardware, it should be noted that these examples are merely illustrative and should not be considered as limiting. For example, it is contemplated that any or all of the hardware, software, and firmware components could be embodied exclusively in hardware, exclusively in software, or in any combination of hardware and software. Accordingly, while the following describes example methods and apparatus, persons of ordinary skill in the art will readily appreciate that the examples provided are not the only way to implement such methods and apparatus. For example, while the example methods and apparatus are described in association with Extensible Stylesheet Language Transformation (XSLT) templates, the example methods and apparatus may be implemented by any other template format (e.g., Extensible Markup Language (XML) templates, Electronic Device Description Language (EDDL) templates, etc.) that may be used in industrial applications, manufacturing applications, process control applications, automation applications, etc.

Process control systems generally include controllers to perform routines, control strategies, and/or algorithms that manage field devices located in the control system. The field devices may be, for example, valves, valve positioners, switches and transmitters, and may perform process control functions such as opening or closing valves and measuring process control parameters. In addition to managing field devices, controllers may generate process data based on data received from the field devices. The process data may include process statistics, alarms, monitoring information, process trend information, diagnostic information, field device status information, and/or messages from the field devices.

Controllers transmit process control information to applications operating on workstations so that operators may manage the process control system. Typically, applications display process control information as at least one graphical data representation in a user interface. Data representations are helpful to operators as these data representations typically display process control information graphically in the form of charts, graphs, data tables, list boxes, graphical symbols, text, etc.

To enable users external to a process control system to view process data, some process control systems may utilize one or more external control system servers to store process data. The process control systems (e.g., via the controller) write process data to the external severs periodically or, alternatively, as the process data is generated. Users external to the process control system may access the external servers to view process data. In some examples, users may also modify the process data, thereby causing changes to an operation of the process control system.

Currently, process data is stored to external servers in an interoperability data packing format. Many different types of interoperability data packing formats enable a process control manager to efficiently store significant amounts of process control data (e.g., Terabytes of process control data) in a compressed format. These interoperability data packing formats enable the compressed process data to be accessed relatively quickly upon a request from a user. The interoperability data packing formats also enable process data to be organized based on a process, a process control area, a field device type, and/or any other organization method specified by process control personnel.

One such interoperability data packing format is OPC. The OPC Foundation publishes a set of OPC specifications that define programmatic interfaces that may be used by web browsers and/or client programmatic applications (e.g., Adobe® Flash® player) to access external servers that host process data. These interfaces are defined in terms of methods and/or instances that may be initiated within the servers. Further, the OPC specifications specify parameters that may be passed from OPC-related servers to requesting client applications. The OPC specifications define interfaces that may use different protocols written in procedural programming languages such as, for example, C++, Visual Basic, and/or C#.

To access servers that store process data, clients currently create applications that are executable programs written in a procedural programming language to conform to the protocols of the interoperability data packing interfaces of these servers. The applications are created to provide access to one or more users, regardless of the location of the user, to read, write, and/or subscribe to process data and/or any other type of data that may be stored within a server. The applications may be operated on any computing device (e.g., personal computer, laptop, smartphone, netpad, etc.) so that a user may access process data in any location. In other examples, the applications may be hosted within associated servers as a customized webpage that accesses runtime frameworks, databases, and/or other data sources. An authorized user may access this application via any device capable of connecting to the Internet.

The client applications may have predefined data fields that cross-reference to directory locations within a server that conforms to an interoperability data packing format. The application may pre-format the data fields for a particular display (e.g., text fields, graphs, charts, spreadsheets, etc.) based on the type of process data (e.g., an object type). Further, the client applications may be created for a platform and/or a communication protocol specific to a server. For example, client applications are typically coded with addresses corresponding to desired external servers. Because of these coded features and references to directory locations within a server, the client applications are typically static and may only communicate with one specific server.

By having one specialized client application for each server and/or one application for each portion of data from a server, a client (e.g., a process plant operator or engineer) may need to develop numerous applications to access data on one or more external servers. Additionally, if an interface to a server is modified, a data directory on a server is modified, and/or process data is migrated to a different server, the corresponding client application must be modified to reflect or accommodate the changes. Periodically having to update client applications to access process data on a server can result in instances where some clients may not be able to access process data. Additionally, changes to process data locations can result in broken links between a client application and the process data hosted on a server.

The example methods and apparatus described herein enable a client application at a client location to access any server via a wrapper. The example wrapper functions as an interface between the client and a server by creating data fields and/or data displays based on the process data requested by the client. The example wrapper may use object type (e.g., types of process data) information associated with the requested process data to select an XSLT template.

The example wrapper may also select an XSLT template based on a type of device that is requesting the process data. For example, if a request for process data is received from a device with a relatively large screen area (e.g., a personal computer) the wrapper may select a set of templates configured for a larger screen. Similarly, the example wrapper may select a set of templates configured for a relatively smaller screen if a request is received from, for example, a handheld device (e.g., a smartphone). The example wrapper may identify device types based on, for example, a Media Access Control (MAC) address included within a request.

In some examples, the wrapper may be included within an external server and accessible to a client via a web server application and/or a client display application. In other examples, the wrapper may be installed at a client site (e.g., on a computing device associated with a client and/or user). In yet other examples, the wrapper may be included within a computing device (e.g., a server) that is communicatively coupled between a client and a server.

The example wrapper may be implemented as a web server application and/or a client display application. The web server application is a framework (e.g., an ASP.NET framework application) that creates webpages with process data embedded in data fields, graphs, charts, spreadsheets, etc. that a client may access using a web browser. In the web server application example, the wrapper manages process data (e.g., objects) within a webpage. In contrast, the client display application (e.g., an ActiveX control and/or a Silverlight™ application) is a framework that can be displayed as a runtime application (e.g., a plug-in application) within a web browser. In these examples, the client display application may be installed in a computing device at the client location. The client display application may be initiated within a web browser when the web browser accesses and/or communicates with a wrapper located at an external server. Additionally, the client display application may configure received data and/or data field information from the wrapper such that the data is displayed within data fields, graphs, charts, spreadsheets, etc. within the web browser.

The example wrapper described herein may include an adaptor to communicate with one or more external control system server(s) associated with an interoperability data packing format. The adaptor may use, for example, Transmission Control Protocol (TCP), Hypertext Transfer Protocol (HTTP), and/or Extensible Markup Language (XML) to communicate with a server to access process data requested by a client. The example wrapper also includes a convertor to convert interoperability data packing format formatted process data received from a server to a webpage format. A webpage format may include Hyper Text Markup Language (HTML) and/or any other format for display within a client display application and/or for display within a webpage. Further, the wrapper includes a web-based interface that communicates the process data to a web browser viewable to a client via a webpage and/or a client display application.

The example wrapper may automatically create, configure, and/or format data fields for requested process data (e.g., objects) by determining one or more types of the requested process data. The types of process data may include, for example, server identification information, parameters, properties, file directory organization information, numerical data, string data, status data of a control device, alarm data, and/or any other data that may be associated with a process control system, a manufacturing system, etc. In some examples, the wrapper may determine a data type by metadata embedded and/or associated with the process data. In other examples, the wrapper may determine a data type based on the contents of the process data. By determining data types, the example wrapper can create appropriate data fields with the corresponding process data for display within a web browser. The data fields for displaying process data may include spreadsheets, text fields, numerical fields, graphs, charts, animations, etc.

By automatically creating data fields and populating (e.g., embedding) those data fields with requested process data, the example wrapper eliminates the need for a client to create request-specific applications to access data on external control system servers. Because the example wrapper dynamically formats the data fields based on data type, any changes to a server and/or to process data locations within servers do not affect the ability of a client to access process data. In other words, a client can access process data without having to know how a server is managed, how process data is allocated within a server, how process data is migrated, and/or the type of the process data. Further, because the process data may be accessed by a web browser via the wrapper, the client does not need to create an application that explicitly binds to a communication protocol, an interface protocol, an interoperability data packing protocol, and/or an operating protocol of a particular server. Additionally, the example wrapper may be implemented for any server regardless of protocols associated with the server. Furthermore, because the example wrapper is not configured for a specific server protocol, the wrapper may be installed and/or maintained more efficiently than interoperability data packing server specific applications.

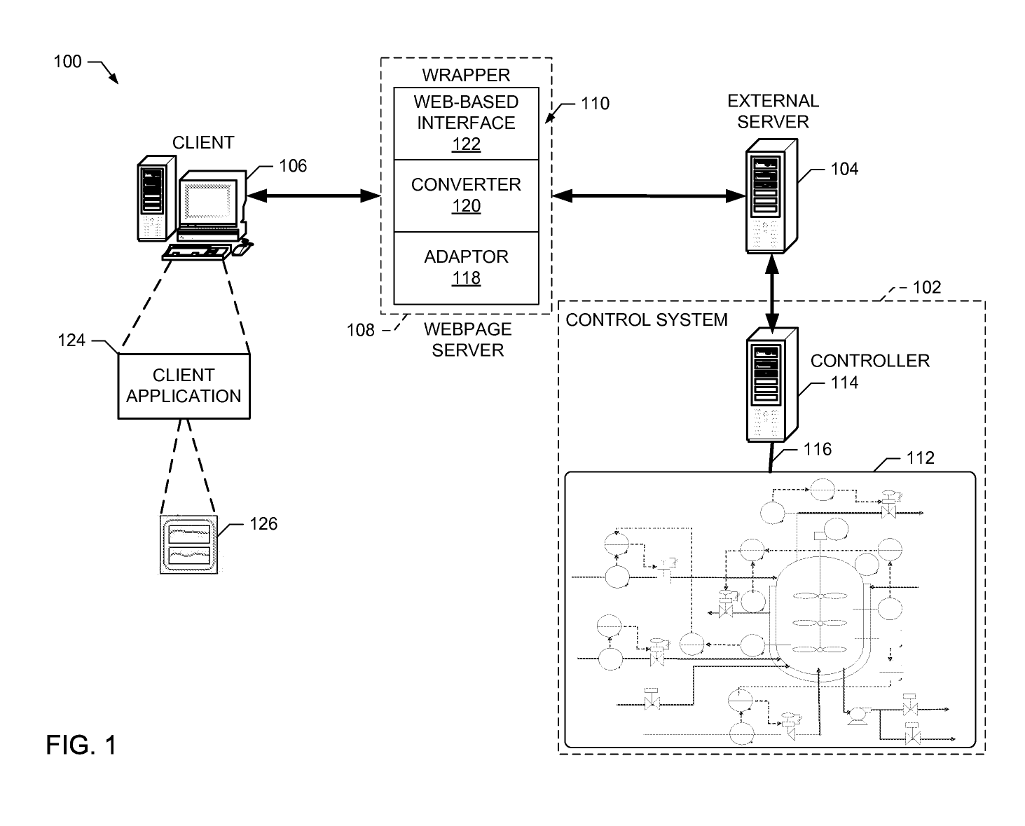

FIG. 1 is a block diagram illustrating a control environment 100 with an example control system 102 communicatively coupled to an external server 104 that is accessible by a client 106 via a webpage server 108 that uses a wrapper 110. The external server 104 may store process data in a format conforming to an interoperability data packing protocol including, for example, a protocol compliant with the OPC specification or standard. While the webpage server 108 and/or the wrapper 110 are shown communicatively coupled to the external server 104, which receives process data from the control system 102, the webpage server 108 and/or the wrapper 110 may be coupled to other external servers that receive process data from other systems, manufacturing facilities, automation facilities, industrial systems, etc. Additionally, while the example external server 104 is shown as communicatively coupled to the control system 102, the external server 104 may be communicatively coupled to other control systems. Furthermore, the example control environment 100 may include additional clients (not shown) that may communicatively couple to the external server 104 via the webpage server 108 and/or other webpage servers (not shown).

The example control system 102 may include any type of manufacturing facility, process facility, automation facility, and/or any other type of process control structure or system. In some examples, the control system 102 may include multiple facilities located at different locations. Additionally, although the example control system 102 shows a process control system 112, the control system 102 may include additional process control systems.

The example process control system 112 is communicatively coupled to a controller 114 via a data bus 116. The process control system 112 may include any number of field devices (e.g., input and/or output devices). The field devices may include any type of process control component that is capable of receiving inputs, generating outputs, and/or controlling a process. For example, the field devices may include input devices such as, for example, valves, pumps, fans, heaters, coolers, and/or mixers to control a process. Additionally, the field devices may include output devices such as, for example, thermometers, pressure gauges, concentration gauges, fluid level meters, flow meters, and/or vapor sensors to measure portions of a process. The input devices may receive instructions from the controller 114 to execute a specified command and cause a change to the process. Furthermore, the output devices may measure process data, environmental data, and/or input device data and transmit the measured data to the controller 114 as process control information (e.g., process data). This process data may include the values of variables and/or parameters (e.g., measured process variables and/or measured quality variables) corresponding to a measured output from each field device.

In the illustrated example of FIG. 1, the example controller 114 may communicate with the field devices within the process control system 106 via the data bus 116. This data bus 116 may be coupled to communication components within the process control system 112. The communication components may include I/O cards to receive data from the field devices and convert the data into a communication medium capable of being received by the example controller 114. Additionally, these I/O cards may convert data from the controller 114 into a data format capable of being processed by the corresponding field devices. In an example, the data bus 116 may be implemented using the Fieldbus protocol or other types of wired and/or wireless communication protocols (e.g., Profibus protocol, HART protocol, etc.).

The controller 114 is communicatively coupled to the external server 104 via any wired and/or wireless connection. In some examples, the connection may include a firewall and/or other security mechanisms to limit access to the controller 114. The controller 114 may transmit process data to the external server 104 upon the controller 114 receiving the process data from the process control system 112. In other examples, the controller 114 may transmit process data to the external server 104 at periodic time intervals (e.g., every minute, hour, day, etc.). Alternatively, the external server 104 may request process data from the controller 114.

Upon receiving process data, the example external server 104 of the illustrated example stores the process data within a file system. The file system may be arranged in a hierarchical manner with directories and/or sub-directories based on the devices within the process control system 112 and/or based on a routine (e.g., application and/or algorithm) operating within the controller 114 to manage the process control system 112. In other examples, the file system may be arranged by an operator of the control system 102. The process data may be stored to a parameter within the associated directory and/or sub-directory. In some examples, the parameter may be a variable associated with a routine operating on the controller 114 or associated with a field device output within the process control system 112. The parameter may include metadata and/or properties that describe the type of process data associated with the parameter. The external server 104 may also store EDDL files for each of the field devices within the process control system 112 that specify how process data is to be displayed.

Each of the directories, sub-directories, files and/or parameters may be assigned an endpoint. The external server 104 may also be assigned an endpoint. These endpoints may be grouped by security access, read access, subscribe access, and/or write access. An endpoint may include an address, a binding element, and/or a contract element that the wrapper 110 may use to access the process data and/or EDDL file stored in the external server 104.

The example wrapper 110 of FIG. 1 is included within and/or used by the webpage server 108. The webpage server 108 is a device and/or an application that functions as an interface between the external server 104 and the client 106. In some examples, the webpage server 108 may be included as an interface within the external server 104. In other examples, the webpage server 108 may be installed within a computing device at the client 106. In yet other examples, the webpage server 108 may be implemented on a server or other computing device that communicatively couples the client 106 to the external server 104. The example wrapper 110 receives requests from the client 106 to access process data (e.g., objects), requests the process data from the external server 104, converts the process data into a format viewable by the client, and creates and/or formats data fields to embed the process data for display within a web browser.

The example wrapper 110 formats data fields by selecting a set of templates that may be viewable by the client 106. In other words, the example wrapper 110 determines which templates are configured to be displayed on a relatively large or small screen size. The example wrapper 110 also formats data fields by selecting within the set of templates a template that matches at least one property and/or object type associated with the requested process data. For example, an XSLT template may include data fields defined as string variables for displaying identification information of a field device. A request for process data may include identification information of a field device. The example wrapper 110 uses metadata and/or property descriptions within the process data to determine that identification information of a field device is to be displayed. The example wrapper 110 then identifies the XSLT template with data fields configured to display the identification information process data. The example wrapper 110 may then combine and/or insert the identification information process data into the appropriate data fields within the selected XSLT template. The example wrapper 110 may then render the XSLT template for display at the client 106.

The client 106 may access the external server 104 to read, write, and/or subscribe to process data. Subscribing to process data may include receiving authorization from the example wrapper 110 and/or the external server 104 to receive periodic and/or continuous updates of requested process data as the process data is transmitted by the controller 114. Reading the process data may include reading the current value of the process data stored in the external server 104. Writing the process data may include receiving values from the client 106 to modify or change a parameter stored as process data within the external server 104. Writing data may also include modifying a status, an alarm and/or a flag associated with the process data. Upon receiving a written value, the example external server 104 may transmit the written value to the controller 114 to change and/or modify an operation of the process control system 112. To enable the client 106 access to the process data, the example wrapper 110 may implement security features including encryption, authentication, integrity codes, and/or user specific access control lists. In examples where a user and/or the client 106 is not authorized to access process data, the example wrapper 110 may provide only read access to the process data or, alternatively, may not provide any access to the process data.

To access the external server 104, the example wrapper 110 includes an adaptor 118. The example adaptor 118 may use TCP, HTTP, and/or XML-based communications to communicate with the external 104 server via any wired and/or wireless connection. The wrapper 110 further includes a converter 120 to convert (combine and/or insert) the process data received by the adaptor 120 into a format that is viewable via a web browser. The example wrapper 110 also includes a web-based interface 122 to select one or more templates to display the process data. The example web-based interface 122 also provides an interface to the client 106 by formatting, rendering, embedding and/or displaying the process data within the select template(s).

The example client 106 may be associated with an individual that may be authorized to read, write, and/or subscribe to process data stored on the external server 104. The client 106 may also be associated with personnel associated with the control system 102 that may access the external server 104 from a remote location. The client 106 may access the external server 104 via the webpage server 108 using any wired and/or wireless communication medium (e.g., the Internet).

In an example where the client 106 generates a request to access process data (e.g., objects), the wrapper 110 receives a request message from the client 106. In particular, the web-based interface 122 may receive the request. Upon receiving the request, the web-based interface 122 forwards the request to the adaptor 118. The adaptor 118 uses information within the request (e.g., a Uniform Resource Locator (URL) destination address) to identify an external server (e.g., the external server 104) that stores the requested process data. The adaptor 118 then accesses the external server 104 to retrieve the process data. The adaptor 118 may use endpoints associated with the process data to access and/or read the process data. The adaptor 118 then forwards the process data received from the external server 104 to the convertor 120, which converts the process data from a format associated with the interoperability data packing format to a web browsing format. The convertor 120 then forwards the process data to the web-based interface 122. The web-based interface 122 then selects one or more templates to embed, combine, and/or place at least a portion of the converted process data into one or more corresponding template data fields for display via a web browser in a webpage viewable by the client 106.

The web-based interface 122 may combines process data with one or more data fields of a template by partitioning the process data by types and/or properties, determining which data type and/or property is associated with a data field, and placing the data associated with each data type into the associated data field. In some examples, the web-based interface 122 may create data fields within a template. The web-based interface 122 may identify a data type and/or property within the process data by locating metadata associated with each portion of the process data and cross-referencing the metadata to the associated data field.

The example web-based interface 122 combines process data with one or more templates such that the process data is viewable by the client 106 using a client application 124. The example of FIG. 1 shows the client application 124 displaying process data in an interface 126 that may include a web browser. The client application 124 may include a web server application and/or a client display application. The wrapper 110 may format process data for a web server application by creating a webpage and/or accessing an XSLT webpage template and placing or embedding the data fields within the template. The interface 126, via a web browser, may then display the process data by accessing the webpage hosted by the wrapper 110 and/or the web page server 108 using HTML requests and responses.

Alternatively, the wrapper 110 may format the process data for a client display application by initializing a web application (e.g., ActiveX, Adobe Flash™ and/or Silverlight™) at the client application 124 that is executable within a web browser (e.g., the interface 126). In some examples, the client 106 may download and/or install the client display application prior to viewing the process data. The wrapper 110 transmits the process data, template(s), and/or the data fields to the client display application. In some examples, the wrapper 110 associates process data with corresponding template(s) and/or data fields prior to transmitting the process data to the client display application. Upon receiving the process data, the client display application creates (e.g., renders) a display within the web browser (e.g., the interface 126) to view the process data within the corresponding template(s) and/or data fields.

Furthermore, the client 106 may customize the client application 124 by modifying templates and/or data fields. For example, the client 106 may specify a location within the web browser to display a data field. Further, the client 106 may modify the color, text size, numerical convention, and/or any other graphical representation of the process data with the data fields.

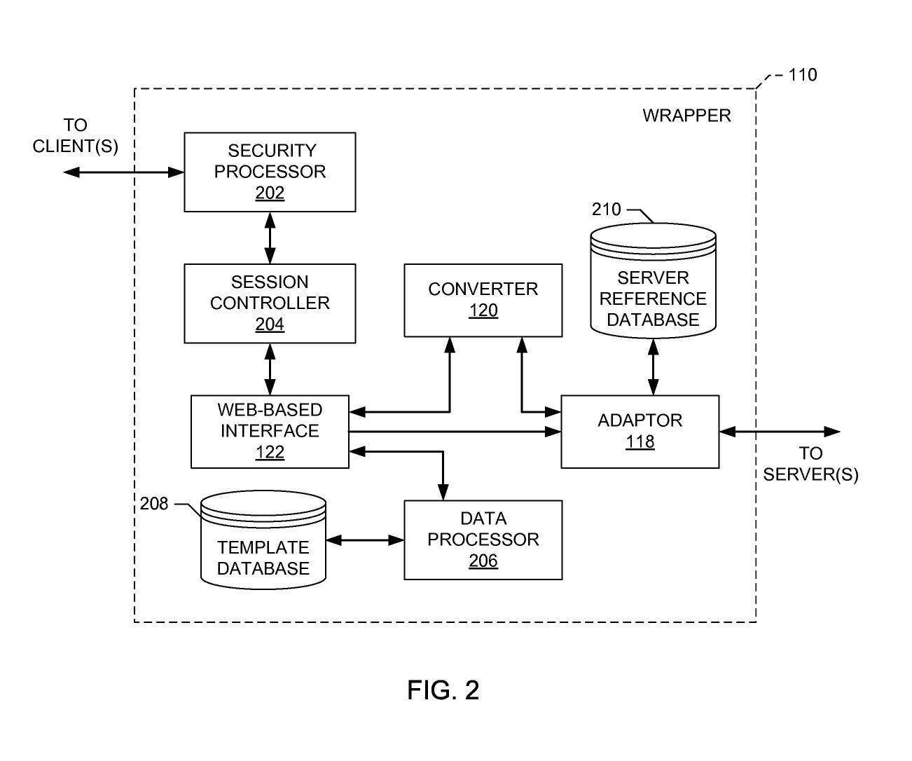

FIG. 2 is a functional block diagram of the example wrapper 110 of FIG. 1. The wrapper 110 includes the adaptor 118, the converter 120, and the web-based interface 122 of FIG. 1. Each of the functional blocks within the wrapper 110 of FIG. 2 may facilitate multiple clients and/or external servers or, alternatively, the wrapper 110 may include respective functional blocks for each communicatively coupled external server and/or functional blocks for each client (e.g., the client 106).

To provide security measures such as encryption and/or endpoint access controls for communications with the client 106 and/or the client application 124, the example wrapper 110 of FIG. 2 includes a security processor 202. The example security processor 202 may include, for example, encryption processors and/or digital signature generators to protect outgoing communications from unauthorized third parties. The encryption processors may use any type of encryption encoders to format communications destined for the client application 124 in a format unreadable to unauthorized users. The digital signature generators protect communications for the client application 124 from being tampered with by unauthorized third parties. The digital signature generators may use any type of cryptographically secure signature generator (e.g., hash codes) that enables the detection of values that have been modified by an unauthorized third party between the client application 124 and the wrapper 110. Additionally, the security processor 202 may include other forms of communication security including authentication mechanisms and/or access controls. The example security processor 202 may decode encrypted, and/or signed communications originating from the client application 124 and/or the client 106. Upon decoding the communications, the security processor 202 transmits the communications to the intended destination within the wrapper 110.

In the example of FIG. 2, the security processor 202 is communicatively coupled to one or more clients including the client 106. The security processor 202 may filter request messages originating from clients and/or other users by identification information so that only authorized clients may access the process data within a desired server. Further, the security processor 202 may forward process data and/or templates to a client display application implemented within the client application 124. In other examples, the security processor 202 enables secure communications between the client 106 and the web-based interface 122 that may host a webpage displaying process data via a template.

To manage data communications between one or more client(s) and the example web-based interface 122, the example wrapper 110 of FIG. 2 includes a session controller 204. The example session controller 204 manages an access session for a client (e.g., the client 106 of FIG. 1) that communicates with the wrapper 110. The access session represents an open communication path between the web-based interface 122 and a client. An access session may be created for each client that accesses the web-based interface 122 because each client may request access to different data sources and/or data types from different external control system servers. Thus, the example session controller 204 ensures that the web-based interface 122 provides a client with only the process data requested by the client.

The session controller 204 initiates a session after receiving a request message to access process data from a client. The request may be from a web browser and/or the client application 124. Until a session is opened by the session controller 204, the session controller 204 may reject any other request from a client. While the session is open, the session controller 204 routes each request message from a client to the web-based interface 122. Additionally, the session controller 204 may store references to selected process data and their associated read or write endpoints that may be associated with data fields and/or process data viewable in a webpage.

The example web-based interface 122 included within the wrapper 110 of FIG. 2 provides an interface to clients by managing, formatting, and/or configuring process data. The web-based interface 122 receives process data (e.g., objects) in a format that is viewable in a web browser from the converter 120. The example web-based interface 122 also processes requests from clients to access process data. Upon receiving a request from a client, the web-based interface 122 initiates an access session by sending an instruction to the session controller 204 and forwarding the request to the adaptor 118. In some examples, the web-based interface 122 receives the request after the security processor 202 determines that the request is associated with an authenticated client. Additionally, the web-based interface 122 may close an access session when a client closes and/or terminates a web browser and/or when a client application sends an instruction to terminate the session.

When the web-based interface 122 receives process data associated with a request, the web-based interface 122 determines one or more data type(s) and/or properties associated with the process data by forwarding the process data to a data processor 206. The example data processor 206 identifies metadata and/or properties that may be included within portions of the process data. Additionally, the data processor 206 accesses a template database 208 to cross-reference process data to a corresponding template and/or data field based on a value type, property, variable type, and/or any other identifier that may be associated with process data. The example template database 208 may be implemented by Electronically Erasable Programmable Read-Only Memory (EEPROM), Random Access Memory (RAM), Read-Only Memory (ROM), and/or any other type of memory.

The example data processor 206 of FIG. 2 associates and/or combines process data with a data field by, upon determining data type(s) associated with the process data, searching for matching templates within the template database 208. The templates may conform to, for example, the XSLT protocol. Alternatively, the data processor 206 may generate an XSLT template from one or more EDDL files associated with the retrieved process data. In these examples, the EDDL files may define how the process data is to be displayed. The example data processor 206 assigns process data to one or more data display variables (e.g., parameters) of a data field within a template that may be cross-referenced to a data type and/or property. The data processor 206 and/or the web-based interface 122 may also store, embed, and/or reference numerical, alphanumeric, and/or flag values of the process data to the appropriate data field within a template.

The data processor 206 accesses the template database 206 to select a template to display the process data. The template may include a XSLT template that converts XML information (e.g., process data) into HTML for display within a web browser. The data processor 206 may select a template based on a type of the process data, values of the process data, properties of the process data, and/or target display information. Target display information may identify a type of web browser and/or a device that is to display the process data. For example, target display information may indicate if process data is to be displayed on a smartphone web browser or a web browser on a workstation. A template for a smartphone may be configured to display process data on a relatively small screen compared to a template for a workstation web browser.

The example web-based interface 122 of FIG. 2 receives the data type(s) and/or properties of the process data from the data processor 206 and compiles matching template(s). The web-based interface 122 may then embed, combine, and/or otherwise place the process data (e.g., the compiled portions of the process data associated with the respective data fields) into the appropriate data fields of a template. The web-based interface 122 embeds the portions of the process data into the data field(s) by partitioning the process data by the data type(s), using the information and/or template(s) from the data processor 206 to determine which data type is associated with a data field of a template, and placing the process data associated with each data type into the associated data field of the template. In some examples, a data field may be associated with more than one data type. The web-based interface 122 may then embed the process data in a template webpage that includes the data field(s).

In examples where a client may request process data using a client application (e.g., the client application 124), the example web-based interface 122 determines the type of application. The web-based interface 122 may determine the type of client application by identifying a protocol and/or application language associated with the request message and/or any metadata associated with the client application within the request message. For example, a client that uses a web server application may include protocols associated with the ASP.NET application, while a client that uses a client display application may include protocols and/or messages associated with a Silverlight™ or an ActiveX application. Based on the type of client application, the example web-based interface 122 creates and/or configures the appropriate web browser and/or programmatic interface to display the process data within an appropriate template. For example, the web-based interface 122 may instruct the data processor 206 to search for templates that correspond to a certain type of client display application.

Upon determining a client application type, the web-based interface 122 and/or the data processor 206 formats the process data, and/or templates for display by generating a display file. The display file may conform to the client application type. In this manner, a display file may be transmitted to a client to display the process data in a layout specified by the template and/or an EDDL file. In examples where the client application 124 is associated with a web server application, the web-based interface 122 receives a request from the client 106 via a web browser, forwards the request to the adaptor 118 to access the process data and/or corresponding EDDL files, and receives the process data from the converter 120. The request from the client 106 via the web browser may be in the form of an HTML document. Further, the web-based interface 122 may send an instruction to the session controller 204 to associate the web browser of the client 106 with the newly created session. The web-based interface 122 then creates a webpage (e.g., a display file) with the template including the embedded process data. The templates may include, for example, lists, spreadsheets, graphs, charts, graphical indications, animations, etc. Further, the locations of data fields may be specified by the template. The process data to be inserted into a template may also be specified by an EDDL file. The web-based interface 122 transmits the contents of the webpage template as a display file to the web browser of the client 106 to display the webpage at the client location. The process data within the webpage template is transmitted by the web browser to the client 106 in a formatted context via any HTTP, XML, XSLT, and/or any other Internet webpage transmission format.

In examples where the web browser includes a client display application, the example web-based interface 122 receives a request from the client 106 via a web browser, forwards the request to the adaptor 118 to access the process data, receives the process data from the converter 120, and initiates the client display application within the web browser. The web-based interface 122 may send an instruction to the data processor 206 for a client display application template based on properties of the process data. The web-based interface 122 may then display the process data within a client display application as a display file via the web browser. The request from the client 106 via the web browser may be in the form of a method call. Upon formatting and/or configuring the process data for display within a template to generate the display file, the web-based interface 122 transmits the display file to a client in a format associated with protocols of the client display application. The client display application then creates a display in the web browser at the client location showing the process data within the associated data fields of the template.

The client display application may include any programmatic client that, in some examples, may access the web-based interface 122 without a web browser. In these examples, the web-based interface 122 associates the programmatic client with the newly created access session and forwards process data formatted for display within a template to the client as a display file via any protocols associated with the programmatic client. The programmatic client then creates a display via the display file that shows the process data within associated data fields.

The example web-based interface 122 provides clients with read access, write access, and/or subscribe access. For clients that request read access, the web-based interface 122 forwards a single request to the adaptor 118 for current process data and/or a corresponding EDDL file. Upon receiving and formatting the process data, the web-based interface 122 provides the client application(s) with the requested process data.

Alternatively, when clients request subscribe access, the web-based interface 122 may send periodic messages to the adaptor 118 to receive process data at time intervals. In some examples, the client may specify the time intervals to receive process data. Further, after the web-based interface 122 creates a webpage and/or a display template for a programmatic application, the web-based interface 122 provides periodic and/or continuous updates to the data fields within the template with more recent process data. The web-based interface 122 provides the updates via an already active access session that maintains communication with a requesting client. The updates to the data fields may include updating trend graphs, process status alerts, and/or flags with the most recent process data stored to corresponding external control system server. Thus, the web-based interface 122 enables a client to access the most recent process data without having to refresh a web browser and/or without having to periodically request the process data.

In yet other examples where clients may request write access, the example web-based interface 122 receives the written process data value from the webpage and/or programmatic application via an HTML document or a method request. The web-based interface 122 then identifies a variable and/or parameter associated with the written data value. In other examples, the web-based interface 122 may access the data processor 206 to cross-reference the data value to a data type specified within the template database 208. The web-based interface 122 then sends an instruction to the converter 120 and/or the adaptor 118 to forward the data value to the appropriate variable and/or portion of the external server. The external server may then store the written data value and/or forward the written data value to the appropriate location within a controller.

The example web-based interface 122 may store client customization information to a database (not shown) so that the next time the same client requests the same type of process data, the web-based interface 122 may format the process data within template(s) based partly on the prior customization of the client. The web-based interface 122 may identify client customization by any modifications performed by a client through a web browser and/or a programmatic application to alter the appearance and/or data display of the process data within the data field(s). A client may modify a color, a text size, a numerical convention, and/or any other graphical representation of the process data.

To access external control system servers (e.g., the external server 104), the example wrapper 110 of FIG. 2 includes the adaptor 118. The example adaptor 118 may use TCP, HTTP, XML, and/or any other transmission protocol to communicate with the external server(s) via any wired and/or wireless connection. The adaptor 118 receives requests to access an external server from the web-based interface 122. Upon receiving a request, the adaptor 118 identifies an external server that stores process data by accessing a server reference database 210 to cross-reference a client request to a particular external server. The example server reference database 210 may be implemented by EEPROM, RAM, ROM, and/or any other type of memory.

In some examples, the client request may include a web address and/or an identifier of an external server. The adaptor 118 may reference the server reference database 210 to determine a location of the requested external server. In some examples, the adaptor 118 may access two or more external servers to access requested process data and/or corresponding EDDL files. Upon determining the location of the external server, the adaptor 118 sends a request to the external server for the process data. The adaptor 118 may access the process data on the external server by determining a directory and/or file structure of the process data stored on the server. The adaptor 118 may relay this directory and/or file structure to the web-based interface 122 to enable a client to select one or more directories and/or sub-directories via a web browser and/or programmatic application. By selecting the directories and/or sub-directories, the client specifies the process data desired to be viewed and/or accessed. In other examples, the client may include the directory and/or sub-directory location of the desired process data. In yet other examples, the client may specify variable names, process data identifiers, and/or any other data identification information that the adaptor 118 may use to navigate through an external server to access the requested process data.

The example adaptor 118 may navigate through the directories, sub-directories, and/or files of an external server using assigned endpoints. For example, the adaptor 118 may access the external server reference database 210 to identify an endpoint corresponding to an external server. The external server may then return endpoints to the adaptor 118 associated with process data based on a hierarchy, read access, write access, and/or subscribe access. The adaptor 118 may then determine which endpoint(s) are associated with the requested process data and uses the endpoint(s) to browse and/or locate the locations within the external server that store the process data.

In examples where the adaptor 118 receives a read and/or a subscribe instruction from the web-based interface 122, the adaptor 118 may access corresponding read and/or subscribe endpoints associated with the requested process data. Further, in examples where a client may specify a periodic interval to receive process data (e.g., subscribing to process data), the adaptor 118 may poll the external server at the periodic interval for desired process data.

In yet other examples where a client may write a process data value to a data field, the adaptor 118 receives the value and/or the associated value identifier from the web-based interface 122. The adaptor 118 then navigates through the external server (e.g., using write endpoints) to locate the file and/or directory location associated with the written data value. The adaptor 118 then stores the written value to the appropriate location within the external server. In some examples where a client may write a value, the adaptor 118 may receive the value after the converter 120 converts the value from a webpage and/or programmatic application format to an interoperability data packing format.

The example adaptor 118 of FIG. 2 includes functionality that enables the adaptor 118 to interface and/or communicate with different external servers that may be operating with different protocols, interfaces, operating systems, and/or file systems. The server reference database 210 may include references to the protocols, interfaces, operating systems, and/or file systems associated with each external server. Then, when the adaptor 118 identifies an external server to access, the adaptor 118 may use the protocol, interface, operating system, and/or file system information associated with the external server to appropriately communicate and/or interface with the external server.

Upon receiving and/or accessing the requested process data from an external server, the example adaptor 118 forwards the process data to the converter 120. The example converter 120 of FIG. 2 converts process data and/or EDDL files from any interoperability data packaging-related format to a format that is viewable within a web browser and/or any other programmatic application. Upon converting the process data to a web browsing format and/or any other programmatic application format, the converter 120 forwards the converted process data to the web-based interface 122. The example converter 120 may also convert a compressed EDDL file into a format (e.g., XML and/or XSLT) that may be utilized by the data processor 206 to display process data within a template. Further, the converter 120 may receive written values and/or process data from the web-based interface 122. In these examples, the converter 120 converts the web browsing and/or programmatic application format of the written data into a format that the adaptor 118 may use to store the written data to an external server. The converter 120 may use any application, framework, data conversion algorithm, etc. that may be specified by any data packaging convention.

While the example wrapper 110 has been illustrated in FIG. 2, one or more of the servers, platforms, interfaces, data structures, elements, processes and/or devices illustrated in FIG. 2 may be combined, divided, re-arranged, omitted, eliminated and/or implemented in any way. Further, the example security processor 202, the example session controller 204, the web-based interface 122, the example converter 120, the example adaptor 118, the example data processor 206, the example template database 208, the example server reference database 210 and/or, more generally, the example wrapper 110 may be implemented by hardware, software, firmware and/or any combination of hardware, software and/or firmware. Thus, for example, any of the example security processor 202, the example session controller 204, the web-based interface 122, the example converter 120, the example adaptor 118, the example data processor 206, the example template database 208, the example server reference database 210 and/or, more generally, the example wrapper 110 could be implemented by one or more circuit(s), programmable processor(s), application specific integrated circuit(s) (ASIC(s)), programmable logic device(s) (PLD(s)) and/or field programmable logic device(s) (FPLD(s)), etc.

When any apparatus claim of this patent is read to cover a purely software and/or firmware implementation, at least one of the example security processor 202, the example session controller 204, the web-based interface 122, the example converter 120, the example adaptor 118, the example data processor 206, the example template database 208, and/or the example server reference database 210 are hereby expressly defined to include a computer readable medium such as a memory, DVD, CD, etc. storing the software and/or firmware. Further still, the example wrapper 110 may include one or more elements, processes and/or devices in addition to, or instead of, those illustrated in FIG. 2, and/or may include more than one of any or all of the illustrated elements, processes and devices.

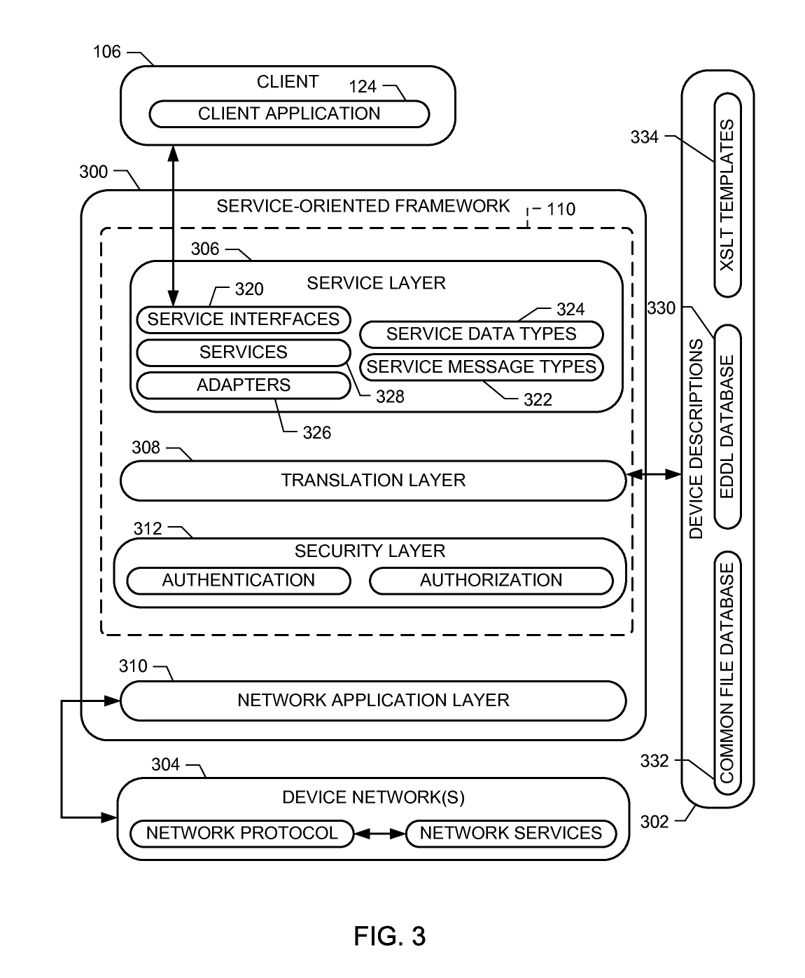

FIG. 3 is a block diagram of an example service-oriented framework 300 that may be used to implement the example wrapper 110 of FIGS. 1 and 2. The example service-oriented framework 300 provides a service-oriented architecture to improve the flexibility of a control system (e.g., the control system 102 of FIG. 1). As illustrated in FIG. 3, the service-oriented framework 300 is in communication with the client 106, a device description layer 302, and one or more device network (s) 304. The client includes the client application 124, which transmits requests for process data to the service-oriented framework 300. The service-oriented framework 300 includes a service layer 306, a translation layer 308, a network application layer 310, and a security layer 312.

The example wrapper 110 may be implemented by the example service layer 306, the translation layer 308, and the security layer 312. The service layer 306 includes service interfaces 320, service message types 322, service data types 324, adapters 326, and services 328. Example services 328 provided by the service layer 306 include transmitting process data and templates to the client 106 for display. Services may also include subscribing to process data and/or writing process data to the device network(s) 304. The services 328 are exposed as service contracts, which allow applications and/or devices to request the services 328 to execute desired capabilities or functions.

The service layer 306 is accessed by the client 306 through the service interfaces 320. The service layer 306 manages service requests from the client application 124 and translates service contracts for use by the client 106. When passing messages between a service and the client 106, one or more adapters 326 may be used to transform the messages into formats that the client 106 can understand. Access to the service layer 306 is defined by policies. Policies provide a way for the client 106 to determine the types of connections, security requirements for accessing services, and/or any other details related to requesting services.

The translation layer 308 translates between protocols. For example, the translation layer 308 may implement the converter 120 and translate process data from an interoperability data packing format to a web-browsing format. In other examples, the translation layer 308 may convert process data into a Field Device Integration (FDI) format from a device network-specific protocol (e.g., e.g. HART, Fieldbus, Profibus). The example translation layer 308 receives information about process data from the device description layer 302. The device description layer 302 includes field device EDDL files stored in an EDDL database 330 and/or in a common file format database 332. The databases 330 and 332 may be implemented within the control system 102. Additionally, copies of the databases 330 and 332 may be included within, for example, the external server 104. In this manner, the wrapper 110 may access the EDDL database 330 and/or the common file format database 332 for descriptions of how process data is to be displayed within templates. The common file format database 332 stores information about devices and/or applications. In some examples, the common file format database 332 uses a schema that includes XML files to describe functionality of field devices.

The example device description layer 302 includes an XSLT templates database 334 (e.g., the template database 208). The translation layer 308 may access the XSLT template database 334 for XSLT templates that match process data that is to be displayed. The translation layer 308 may also use EDDL files from the EDDL database 330 to determine how the process data is to be embedded and/or combined within the XSLT templates. The example translation layer 308 uses the process data within the XSLT templates to generate a display file that is used by the service layer 306 to provide process data via the service interface 320 to the client application 124. The translation layer 308 may include an application facade that processes the templates for display.

In some cases it may be necessary to restrict access from the client 106 to the device networks 304. To support this requirement, the service-oriented framework 300 includes the security layer 312 to provide authentication and/or authorization (e.g., via the security processor 202 of the wrapper 110). The implementation of authentication may be dependent on the type of service host that is being used. Thus, service-oriented framework 300 enables the utilization of one or more security layers. For example, if the service-oriented framework 300 is hosted in Internet Information Services (IIS), the authentication support provided by IIS is used. Alternatively, if the service is hosted by a Windows Service, a message-based or transport-based authentication is used.

The example service-oriented framework 300 includes the network application layer 310 to receive process data from the device networks 304. The network application layer 310 includes data access functionality to interact with one or more of the device networks 304. The example framework 300 may include multiple network application layers 310, each of which may be specific to a particular device network such as HART, Fieldbus, and/or Profibus. In some examples, the network application layer 310 may implement the external server 106 by providing a transport layer of the process data from the control system 102. The network application layer 310 may also include network message types, network data types, and/or an object directory (e.g., a process control directory) that organize and classify process data within the external server 106. For example, network data types may provide property information used by the wrapper 110 to identify matching templates and/or data fields to embed corresponding process data. Additionally, the wrapper 110 may use the object directory to relatively quickly locate requested process data.

The device networks 304 provide the example framework 300 with the ability to configure devices, access device diagnostics, transfer measurement values, transfer alarms and events, and/or other communication and control capabilities. Some example capabilities supported by the service-oriented framework 300 include requests and/or responses, publishing and/or subscribing, transmitting events, maintaining a directory of applications and/or devices, and/or writing commands to devices. The service-oriented framework 300 provides the client 306 with access to these capabilities via the service layer 306. For example, the service-oriented framework 300 may have services defined for request/response, publish/subscribe, events, directory, and write capabilities.

The device networks 304 include network protocols and network services to communicate with the field devices within the process control system 112. The device networks 304 may also include the controller 114 and/or a communication medium between the controller 114 and the external server 104. In this manner, process data generated by field devices is processed and stored to the external server 304 via the device networks 304. The device networks 304 may also transmit data written by the client 106 to the appropriate field device.

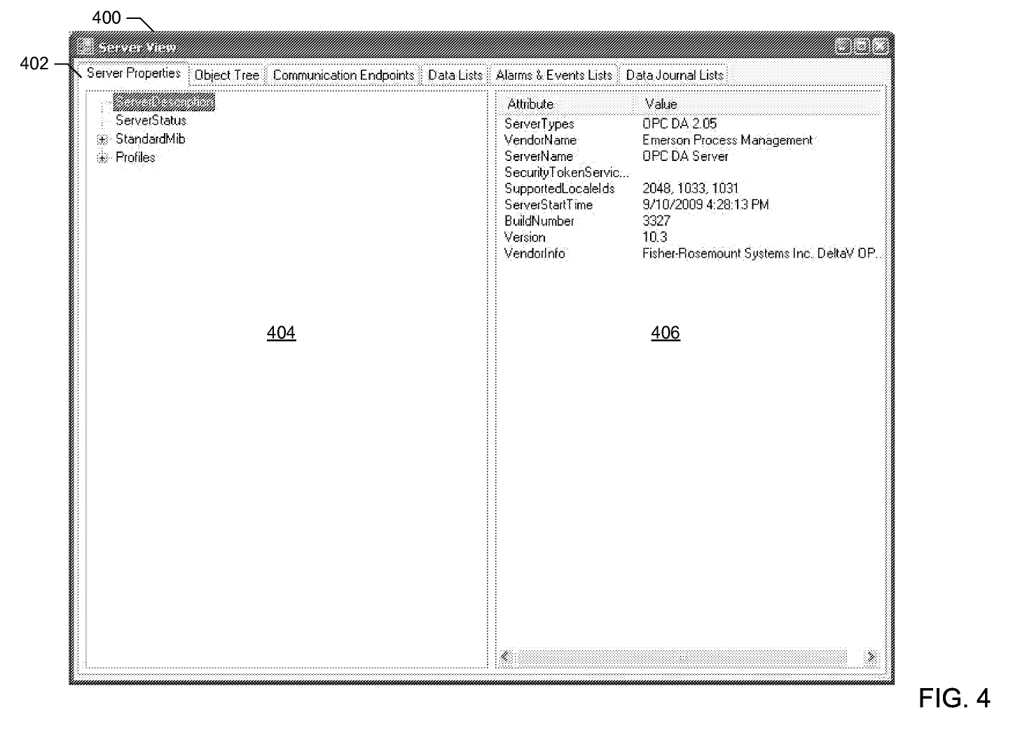

FIG. 4 shows an example interface 400 for server identification process data displayed in a web browser. The interface 400 is shown as an application window. However, in other examples, the interface 400 may include navigation functions associated with a web browser and/or any other programmatic client. Further, while the example interface 400 is shown as one way of displaying process data in data fields, other example interfaces may be created to display process data.

The example of FIG. 4 shows the interface 400 displaying server identification information associated with a Server Properties tab 402. The interface 400 includes a navigation panel 404 and a data panel 406. The panels 404 and 406 may be preconfigured and/or specified by one or more templates (e.g., an XSLT template) and/or style sheets for displaying process data. The example wrapper 110 of FIGS. 1 and/or 2 may use the template or style sheet for arranging and/or embedding data field(s) and the associated process data. For example, the data panel 406 may be preconfigured to display a variable and/or parameter name (e.g., Attribute), and a data value (e.g., Value) associated with process data. The example wrapper 110 may then embed and/or place the data fields associated with the service identification into the Attribute column and/or the Value column. For example, process data describing an external server name may be identified by a “ServerName” Property with a Value of “OPC DA Server.”

A client may access the process data shown in the interface 400 by entering a web address and/or an Internet Protocol (IP) address into a web browser. The web browser may then navigate to the wrapper 110 and/or the webpage server 108 of FIG. 1. The wrapper 110 resolves the web address and/or the IP address to the external server (e.g., the OPC DA Server) shown in the interface 400. The wrapper 110 then retrieves process data associated with the external server, converts the process data into a web browsing format, identifies data type(s) (e.g., properties) of the process data, selects at least one template based on the identified types, embeds the process data into the template(s) and displays the interface 400 to the client via the web browser by rendering the template(s) with the process data. Rendering the template(s) with the process data may include creating a display file to send to the web browser to display the process data within the interface 400. In this example, the wrapper 110 determines the type(s) of process data by identifying properties within metadata that is associated with the data values. The wrapper 110 may then use the properties to embed and/or insert corresponding values of process data into corresponding data fields within the template(s).

In the illustrated example, the navigation panel 404 shows a directory and/or file structure of OPC server identification information associated with the external server. A client may navigate through the directory structure in the navigation panel 404 to select process data associated with OPC server information that is displayed within the data panel 406. The client may selectively view other external server data by selecting the other directories within the navigation panel 404. The example wrapper 110 may retrieve this directory structure (e.g., process data) from the external server and configure the directory structure within data fields using the template of the navigation panel 404.

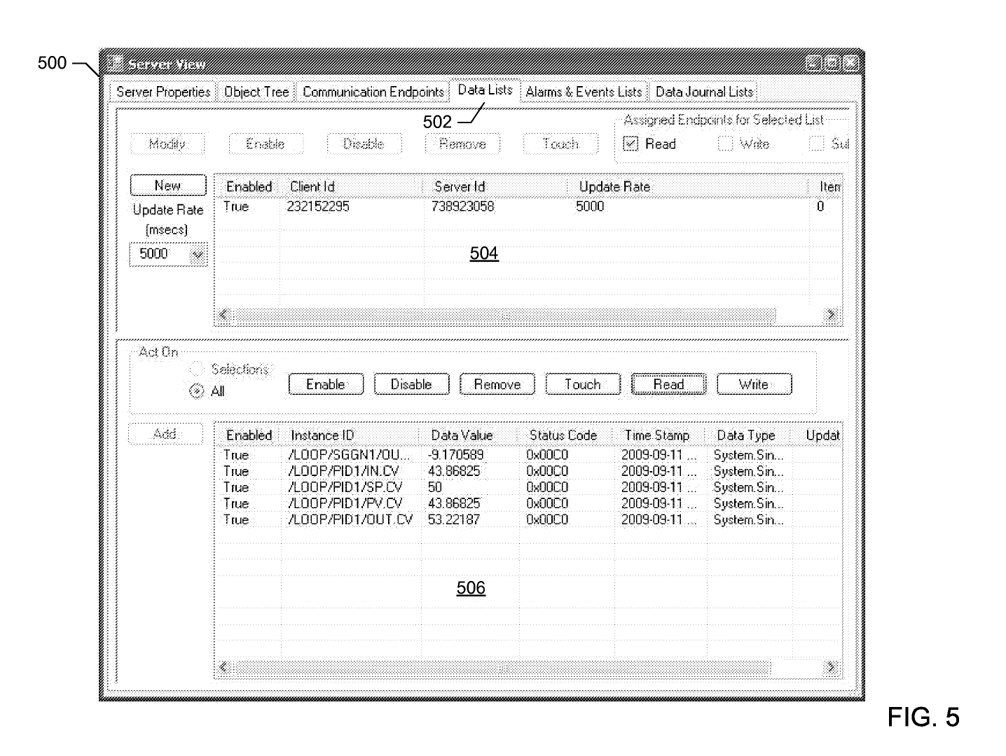

FIG. 5 shows an example interface 500 for process data displayed in a web browser. The process data is shown in the web browser by selecting a Data Lists tab 502. Upon a client selecting the Data Lists tab 502, the example wrapper 110 of FIGS. 1 and/or 2 retrieves process data. The interface 500 includes a subscribe panel 504 and a data panel 506. The layout of the panels 504 and/or 506 may be specified within one or more templates based on the type of process data that is associated with the Data Lists tab 502.

The subscribe panel 504 enables a client to specify a refresh rate for process data displayed in the data panel 506. In this example, the client specifies a 5000 millisecond (msec) update rate. The subscribe panel 504 also includes a client identifier (e.g., Client Id), a server identifier (Server Id), and the selected refresh rate (e.g., Update rate).

The example data panel 506 shows selected process data including a directory location of the process data within the external server (E.g., Instance ID), a data value (e.g., Data Value), a status of the process data (e.g., Status Code), and a time the process data was created (e.g., Time Stamp). The data panel 506 includes buttons to add or remove process data from display. The data panel 506 also includes buttons to read or write the process data.

In the example of FIG. 5, the wrapper 110 determines that the process data to be displayed is associated with a data type and/or property of list-type numerical values. The example wrapper 110 searches for one or more templates that include data fields for displaying numerical process data in a list-type spreadsheet. The example wrapper 110 then embeds the process data into the data fields, generates a display file with the combined process data and templates, and transmits (and/or renders) the display file for display via the interface 500.

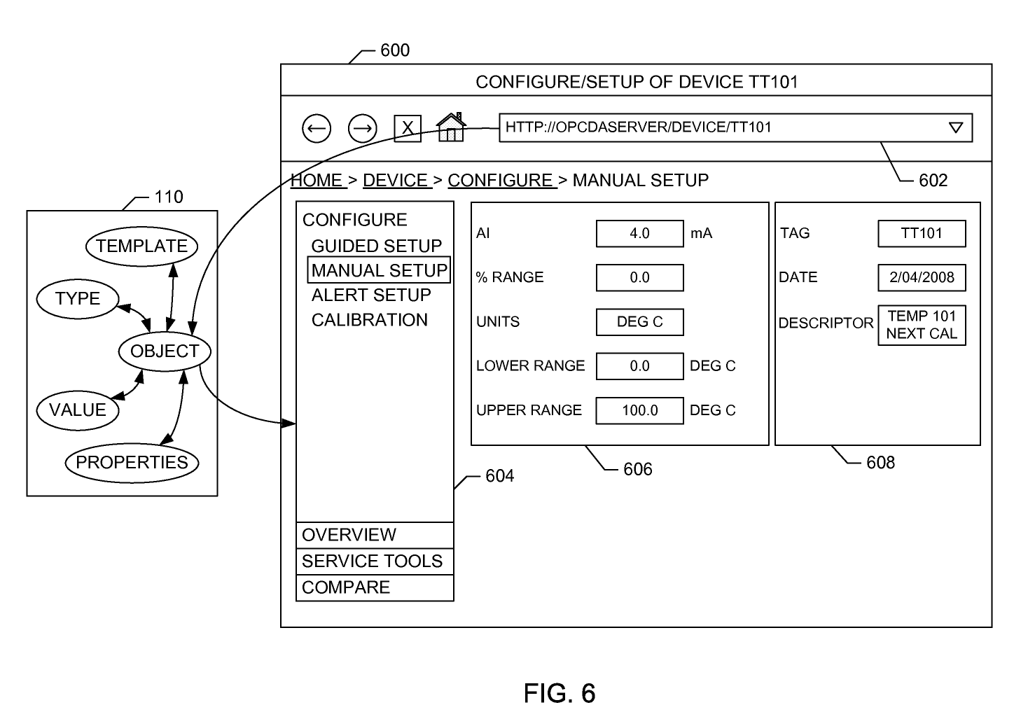

FIG. 6 shows an example interface 600 communicating with the example wrapper 110 to display process data in a web browser. The example interface 600 includes a navigation bar 602 that an operator may use to enter a field device name (e.g., TT101) to view process data associated with the field device. The interface 600 also includes a menu bar 604 that includes options for interfacing with the TT101 field device. In this example, a Manual Setup option is selected.

The example interface 600 of FIG. 6 may provide the wrapper 110 target display information that indicates process data associated with the TT101 field device is to be displayed within a web browser on a workstation or laptop. Additionally, upon selecting or entering a field device (e.g., object), the example wrapper 110 receives the field device name (e.g., TT101). The wrapper 110 uses the field device identifier to identify a type of field device (e.g., an object type), properties associated with the field device, and/or process data (e.g., values) associated with the field device. The wrapper 110 uses this information with the target display information to select a template to display the process data within data fields. The wrapper 110 also uses this information to access the process data from an external control system server. The wrapper 110 may select a template by accessing the template database 208 and locating templates for web browsers operating on a workstation. The wrapper 110 may then narrow the templates based on a device type of the TT101 field device. The wrapper 110 may then select the data field(s) within the template that corresponds to the process data.

In the example of FIG. 6, the wrapper 110 may provide the interface 600 with a template 606 and a template 608. The templates 606 and 608 include data fields with process data (e.g., analog input (AI), % Range, Units, Lower Range, Upper Rage, Tag, Date, and Descriptor) associated with the TT101 field device. The example wrapper 110 may render the process data shown in the templates 606 and 608 by matching and inserting the process data into the appropriate data field(s) based on metadata within the process data. In other examples, templates may include graphs, charts, graphics, and/or any other data representation.

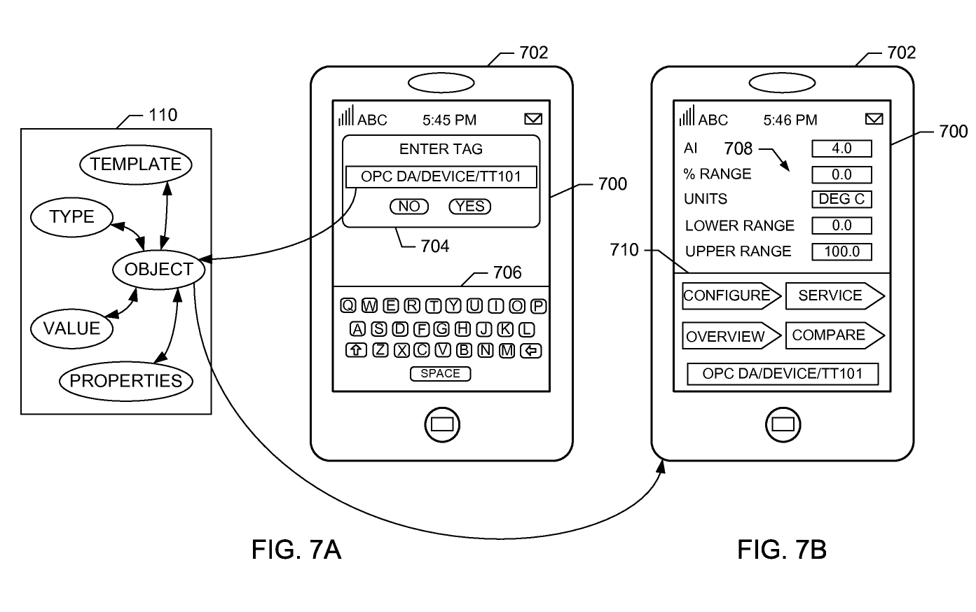

FIGS. 7A and 7B show an example interface 700 displayed on a wireless device 702 communicating with the example wrapper 110 of FIGS. 1 and/or 2 to display process data in a client application. The wireless device 702 may include any portable computing device including, for example, a smartphone, a personal digital assistant (PDA), a web phone, a netpad, etc. The examples of FIGS. 7A and 7B show the example wrapper 110 rendering process data in a template configured for the relatively smaller screen of the wireless device 702.

In FIG. 7A, the user interface 700 includes an object search field 704 and a keyboard 706. The object search field 704 enables a user to enter a field device identifier (e.g., OPC DA/DEVICE/TT101) via the keyboard 706. The object search field 704 provides the entered TT101 field device to the wrapper 110. Additionally, the wireless device 702 may send the target display information to the wrapper 100. The wrapper 110 uses the TT101 field device identifier (e.g., object type) to locate process data and/or properties associated with the TT101 field device. Also, the example wrapper 110 uses the target display information to select a template 708 formatted for display on the relatively small screen of the wireless device 702.

The wrapper 110 may match, insert, and render the process data in the corresponding data fields of the template 708, as shown in FIG. 7B. Additionally, the wrapper 110 may display a menu bar 710 for navigating to different templates. The menu bar 710 may be included within the template 708 and/or may be specified by navigational process data associated with the OPC DA/DEVICE/TT101 directory location. Alternatively, the display of the menu bar 710 may be managed by the client application. The example of FIG. 7B shows that the wrapper 110 selects the template 708 formatted for the wireless device 702, while in FIG. 6 the wrapper 110 selects the templates 606 and 608 formatted for the web browser on a workstation.

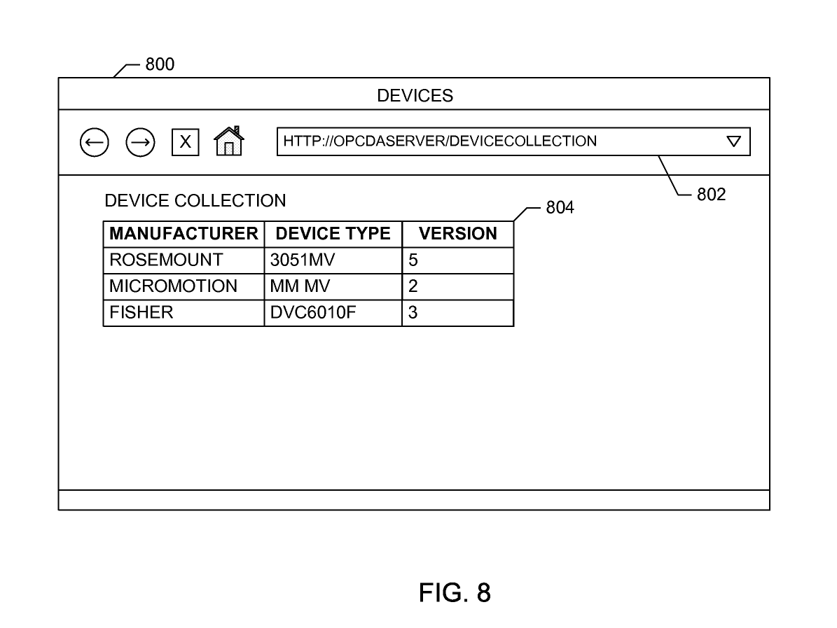

FIG. 8 shows an example interface 800 displaying process data in a web browser. The interface 802 includes a navigation bar 802 that a user may use to enter a file location or path of process data. A XSLT template 804 shows a table of process data displayed within data fields. The XSLT template 804 includes data fields for Manufacturer, Device Type, and Version. A user may provide the HTTP://OPCDASERVER/DEVICE/DEVICECOLLECTION path to access or track process data associated with devices organized within a group. The process data within the template 804 may be accessed from an external server as an XML file:

<?xml version=“1.0” encoding=“UTF-8”?>
<?xml-stylesheet type=“text/xsl” href=“file:///Ccd.xsl”?>
<catalog>

<device>

<manufacturer>Rosemount</manufacturer>
<type>3051MV</type>
<version>5</version>

</device>
<device>

<manufacturer>Micromotion</manufacturer>
<type>MM MV</type>
<version>2</version>

</device>
<device>

<manufacturer>Fisher</manufacturer>
<type>DVC6010F</type>
<version>3</version>

</device>

</catalog>

The example XML file shown above lists the manufacturer, device type, and version of the three field devices under the <catalog> line. In this example, the process data includes the manufacturer name of a field device and the version of a field device (e.g., Rosemount 3051MV field device version 5). The example wrapper 110 may use the path requested by the user to access a corresponding external server and search for process data specified by the path. In this example, the process data is specified within the XML file.

To display the process data via the interface 800, the example wrapper 110 may search for an XSLT template (e.g., the template 804) with data fields that correspond to the properties (e.g., variables) within the XML file. The XSLT template 804 may be defined by the instructions:

<?xml version=“1.0” encoding=“ISO-8859-1”?>
<!-- Edited by XMLSpy ® -->
<xsl:stylesheet version=“1.0”
xmlns:xsl=“http://www.w3.org/1999/XSL/Transform”>

<xsl:template match=“/”>

<html>

<body>

<h2>My Device Collection</h2>
<table border=“1”>

<tr bgcolor=“#9acd32”>

<th>Manufacturer</th>
<th>Device Type</th>
<th>Version</th>

</tr>
<xsl:for-each select=“catalog/device”>

<tr>

<td>
<xsl:value-of
select=“manufacturer”/>
</td>
<td>
<xsl:value-of select=“type”/>
</td>
<td>
<xsl:value-of select=“version”/>
</td>

</tr>

</xsl:for-each>

</table>

</body>

</html>

</xsl:template>

</xsl:stylesheet>

The line <xsl:stylesheet version=“1.0” xmlns:xs1=“http://www.w3.org/1999/XSL/Transform”> specifies the template 804 is to be displayed in the interface 800. The example wrapper 110 may select the template 804 based on information (e.g., target display information, object type, etc) received from the interface 800. For example, the wrapper 110 may match the <manufacturer>property within the XML file to the <xsl:value-of select=“manufacturer”/> data field within the XSLT template 804. The XSLT template 804 also specifies the column headers (e.g., Manufacturer, Device Type, and Version) and instructions (e.g., <xsl:value-of select=“manufacturer”/>, <xsl:value-of select=“type”/>, and <xsl:value-of select=“version”/>) for formatting the process data into data fields.

To generate the displayed version of the XSLT template 804 within the interface 800 of FIG. 8, the wrapper 110 may create a display file by executing the instructions of the XSLT template 804 and referencing the process data in the XML file. In other words, the wrapper 110 combines the process data within the XML file with variables in the instructions of the XSLT template 804 to generate a display file. The wrapper 110 may then render the display file to display the XSLT template 804 with the process data via the interface 800.

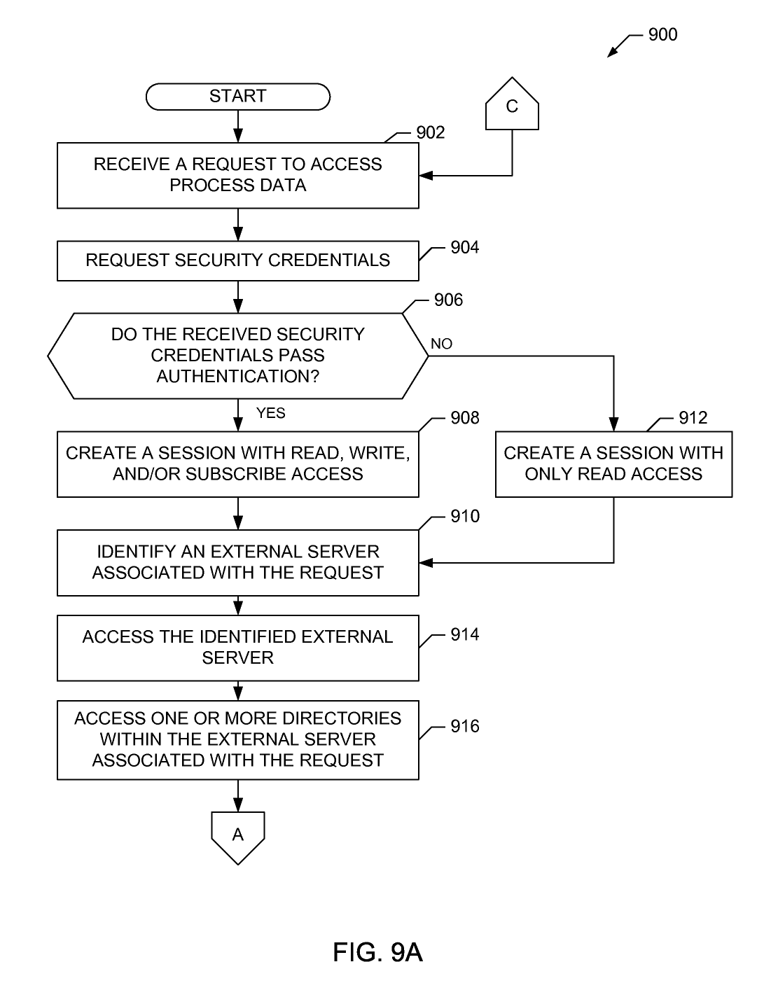

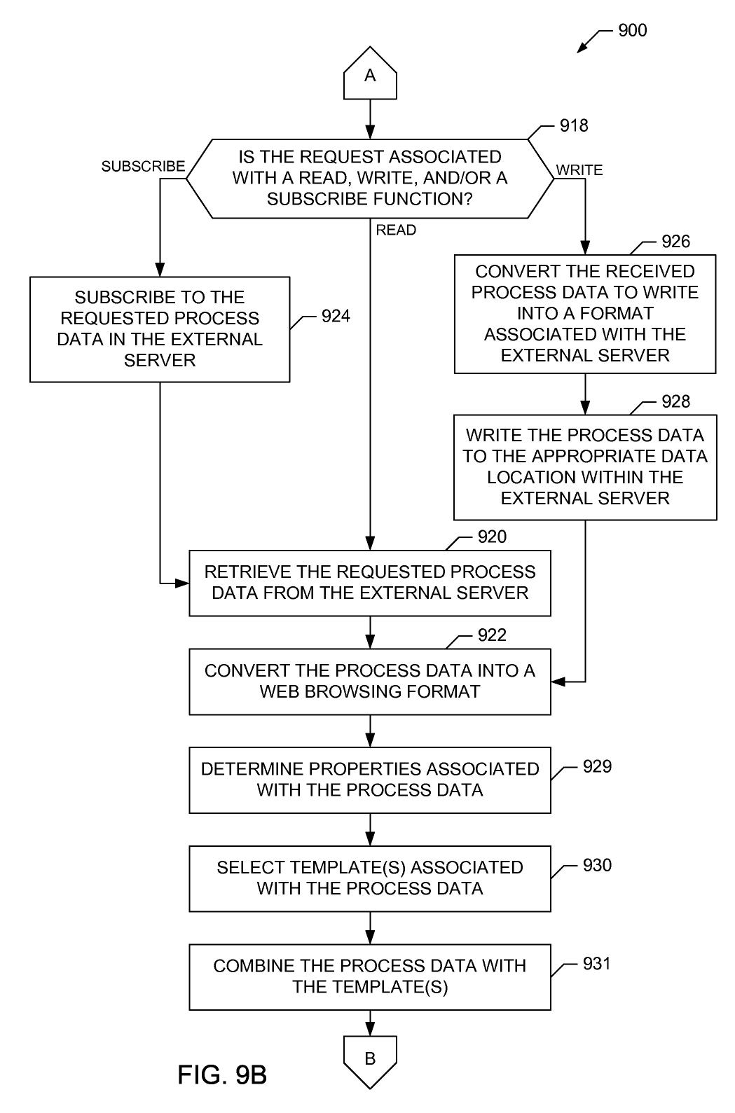

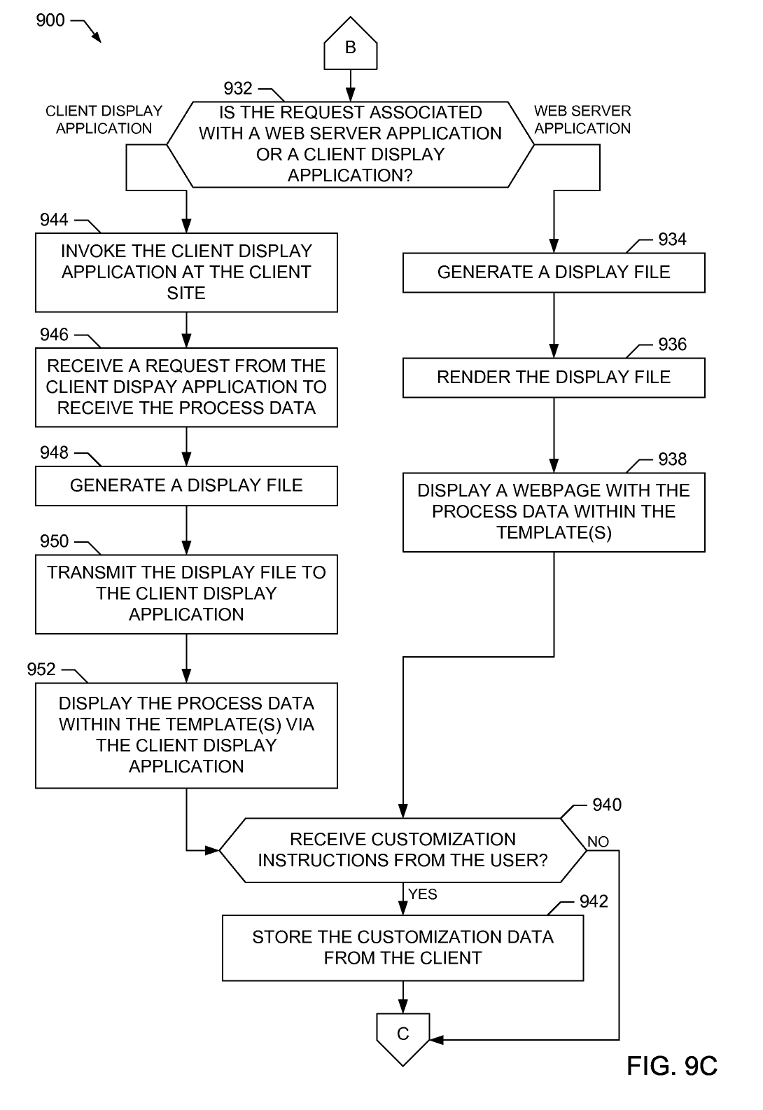

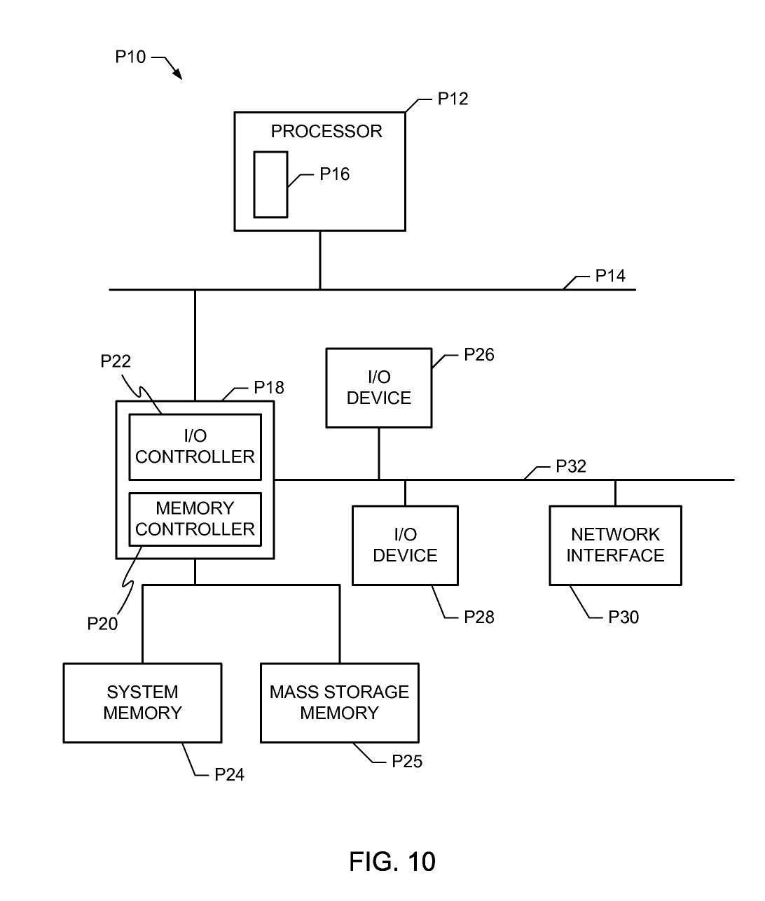

Flowcharts representative of example an processes 900 for implementing the example wrapper 110 of FIGS. 1 and 2 are shown in FIGS. 9A, 9B, and 9C. In this example, the process 900 may be implemented using machine readable instructions in the form of a program for execution by a processor such as the processor P12 shown in the example processor system P10 discussed below in connection with FIG. 10. The program may be embodied in software stored on a computer readable medium such as a CD-ROM, a floppy disk, a hard drive, a digital versatile disk (DVD), or a memory associated with the processor P12, but the entire program and/or parts thereof could alternatively be executed by a device other than the processor P12 and/or embodied in firmware or dedicated hardware. Further, although the example program is described with reference to the flowcharts illustrated in FIGS. 9A, 9B, and 9C, many other methods of implementing the example wrapper 110 may alternatively be used. For example, the order of execution of the blocks may be changed, and/or some of the blocks described may be changed, eliminated, or combined.

As mentioned above, the example process of FIGS. 9A, 9B, and 9C may be implemented using coded instructions (e.g., computer readable instructions) stored on a tangible computer readable medium such as a hard disk drive, a flash memory, a read-only memory (ROM), a compact disk (CD), a digital versatile disk (DVD), a cache, a random-access memory (RAM) and/or any other storage media in which information is stored for any duration (e.g., for extended time periods, permanently, brief instances, for temporarily buffering, and/or for caching of the information). As used herein, the term tangible computer readable medium is expressly defined to include any type of computer readable storage and to exclude propagating signals. Additionally or alternatively, the example process of FIGS. 9A, 9B, and 9C may be implemented using coded instructions (e.g., computer readable instructions) stored on a non-transitory computer readable medium such as a hard disk drive, a flash memory, a read-only memory, a compact disk, a digital versatile disk, a cache, a random-access memory and/or any other storage media in which information is stored for any duration (e.g., for extended time periods, permanently, brief instances, for temporary buffering, and/or for caching of the information). As used herein, the term non-transitory computer readable medium is expressly defined to include any type of computer readable medium and to exclude propagating signals.

The example process 900 of FIGS. 9A, 9B, and 9C enables a client to access process data stored on an external server. Multiple example processes 900 may be executed in parallel or series to access process data for multiple clients. Additionally, in examples where the requested process data may be stored on two or more external servers, the example process 900 may be implemented for each external server or, alternatively, a single example process 900 may be implemented for the external servers.

The example process 900 of FIG. 9A begins by receiving a request to access process data (e.g., via the security processor 200 and/or the web-based interface 122 of FIG. 2) (block 902). The example process 900 then requests security credentials to access the process data (e.g., via the security processor 202) (block 904). Security credentials may include a user name and password, an access code, a unique identifier, etc. In some examples, the security credentials may be included within the request. Next, the example process 900 determines if the received security credentials pass authentication (e.g., via the security processor 202) (block 906). If the security credentials are proper and pass authentication, the example process 900 creates an access session with read, write and/or subscribe access depending on the request from the client (e.g., via the session controller 204) (block 908). The example process 900 then identifies an external server associated with the request (e.g., via the adaptor 118 accessing the server reference database 210 of FIG. 2) (block 910).

However, if the example process 900 is not able to verify the security credentials (block 906), the example process 900 may create an access session with only read access (e.g., via the session controller 204) (block 912). The example process 900 then identifies an external server associated with the request (block 910). Alternatively, if the example process 900 is not able to verify the security credentials (block 906), the example process 900 may deny the client access to the requested process data.

The example process 900 of FIG. 9A continues by accessing the identified external server (block 914) and accessing one or more directories associated with the request (e.g., via the adaptor 118) (block 916). Additionally, in examples where the requested process data is located in more than one external server, the example process 900 may locate the directories and/or files located within the one or more external sever(s) (block 916). The example process 900 may locate the requested process data using endpoints, via manual client navigation, and/or by information provided within the request from the client. After accessing the location of the requested process data, the example process 900 then receives a request to read, write, and/or subscribe to the requested process data. In some examples, the request to access process data may include a request to read, write, and/or subscribe to the process data. In other examples, the client may send another request to access the process data via a read, write, and/or subscribe function.

The example process 900 of FIG. 9B determines if the request is associated with a read, a write, and/or a subscribe function (e.g., via the adaptor 118) (block 918). If the request is to read process data (block 918), the example process 900 continues by retrieving the requested process data from the associated external server(s) (e.g., via the adaptor 118) (block 920). The example process 900 then converts the process data from a format associated with the external server (e.g., an interoperability data packing format) into a web browsing and/or a programmatic application format (e.g., via the converter 120) (block 922).

However, if the request is to subscribe to process data (block 918), the example process 900 continues by subscribing to the requested process data in the external server (e.g., via the adaptor 118) (block 924). The example process 900 may subscribe to the process data by setting an interval of time where a request message is sent to an external server to request the most recent process data. Upon subscribing to the process data, the example process 900 retrieves the requested process data from the external server (e.g., via the adaptor 118) (block 920). Further, the example process 900 may continue to retrieve the requested process data from the external server at the specified intervals. For each retrieval of process data, the example process 900 then converts the process data into a web browsing and/or a programmatic application format (e.g., via the converter 120) (block 922).

If the request is to write process data (block 918), the example process 900 continues by receiving the written data value provided by the client and converting the data value into a formatted value for storing to the external server (e.g., via the converter 120) (block 926). The example process 900 then writes the process data value to the appropriate data location within the external server (e.g., via the adaptor 118) (block 928). The example process 900 may then read the written process data in the external server and convert the process data in to a web browsing format (e.g., via the converter 120) (block 922). The example process 900 may read back a written value to provide evidence to a client that a written value was appropriately written to the external server.

Upon converting process data, the example process 900 continues by determining data type(s) and/or properties that are associated with the process data (e.g., via the data processor 206) (block 929). The example process 900 the selects one or more template(s) based on the properties of the process data (e.g., via the data processor 206) (block 930). The example process 900 may also select the template(s) based on a type of a device that transmitted the request for the process data. The example process 900 next combines the process data with the selected template(s) (e.g., via the data processor 206 and/or the web-based interface 122) (block 931). The example process 900 may combine the process data with the template(s) by inserting and/or embedding the process data into corresponding data fields of the template(s).

The example process 900 of FIG. 9C then determines if the request from the client is associated with a web server application or a client display application (e.g., a programmatic application) (e.g., via the web-based interface 122) (block 932). If the client request is associated with a web server application, the example process 900 creates and/or generates a display file by executing instructions associated with the template(s) that utilized the process data (e.g., via the web-based interface 122) (block 934). The example process 900 then compiles and/or renders the display file (e.g., via the web-based interface 122) (block 936). Next, the example process 900 enables a display of the template(s) including the process data in a webpage that is accessed by a web browser operated by the client (e.g., via the web-based interface 122) (block 938).

Alternatively, if the request from the client is associated with a client display application (block 932), the example process 900 of FIG. 9C invokes the client display application at the client site (e.g., via the web-based interface 122) (block 944). Invoking the client display application may include opening the application within a web browser used by the client to access the process data (e.g., an ActiveX or Silverlight™ application). Invoking the client display application may also include initializing a programmatic application to receive formatted process data and/or data fields. The example process 900 may then receive a request from the client display application indicating the application is invoked and ready to receive process data (e.g., via the web-based interface 122) (block 946). The example process 900 then generates a display file in a format that conforms to the client display application by executing instructions associated with the template(s) that utilized the process data (e.g., via the web-based interface 122) (block 948). The example process 900 transmits the display file to the client display application (e.g., via the web-based interface 122) (block 950). The example process 900 may then display the process data as instructed by the template(s) via the client display application (e.g., via the web-based interface 122) (block 952).

The example process 900 of FIG. 9C continues by determining if the client customized any portion of the process data and/or the template(s) (e.g., via the web-based interface 122) (block 940). If the example process 900 determines that the client did not customize the process data and/or the template(s), the example process 900 reverts back to receiving a request to access process data from the same and/or a different client (block 902 of FIG. 9A). However, if the example process 900 determines that the client customized the process data and/or the data field(s), the example process 900 stores the customization data (e.g., via the web-based interface 122) (block 942). The example process 900 stores the customization information so that the process data can be displayed in the customized format when the same client accesses the same process data at a different time. The example process 900 then reverts back to receiving a request to access process data from the same and/or a different client (block 902).

FIG. 10 is a block diagram of an example processor system P10 that may be used to implement the example methods and apparatus described herein. For example, processor systems similar or identical to the example processor system P10 may be used to implement the example security processor 202, the example session controller 204, the example web-based interface 122, the example data processor 206, the example template database 208, the example converter 120, the example adaptor 118, the example server reference database 210 and/or, more generally, the wrapper 110 of FIGS. 1 and/or 2. Although the example processor system P10 is described below as including a plurality of peripherals, interfaces, chips, memories, etc., one or more of those elements may be omitted from other example processor systems used to implement one or more of the example security processor 202, the example session controller 204, the example web-based interface 122, the example data processor 206, the example data type database 208, the example converter 120, the example adaptor 118, the example server reference database 210 and/or, more generally, the wrapper 110.

As shown in FIG. 10, the processor system P10 includes a processor P12 that is coupled to an interconnection bus P14. The processor P12 includes a register set or register space P16, which is depicted in FIG. 10 as being entirely on-chip, but which could alternatively be located entirely or partially off-chip and directly coupled to the processor P12 via dedicated electrical connections and/or via the interconnection bus P14. The processor P12 may be any suitable processor, processing unit or microprocessor. Although not shown in FIG. 10, the system P10 may be a multi-processor system and, thus, may include one or more additional processors that are identical or similar to the processor P12 and that are communicatively coupled to the interconnection bus P14.

The processor P12 of FIG. 10 is coupled to a chipset P18, which includes a memory controller P20 and a peripheral input/output (I/O) controller P22. As is well known, a chipset typically provides I/O and memory management functions as well as a plurality of general purpose and/or special purpose registers, timers, etc. that are accessible or used by one or more processors coupled to the chipset P18. The memory controller P20 performs functions that enable the processor P12 (or processors if there are multiple processors) to access a system memory P24 and a mass storage memory P25.

The system memory P24 may include any desired type of volatile and/or non-volatile memory such as, for example, static random access memory (SRAM), dynamic random access memory (DRAM), flash memory, read-only memory (ROM), etc. The mass storage memory P25 may include any desired type of mass storage device. For example, if the example processor system P10 is used to implement the wrapper 110 (FIG. 2), the mass storage memory P25 may include a hard disk drive, an optical drive, a tape storage device, etc. Alternatively, if the example processor system P10 is used to implement the example template database 210 and/or the example server reference database 210, the mass storage memory P25 may include a solid-state memory (e.g., a flash memory, a RAM memory, etc.), a magnetic memory (e.g., a hard drive), or any other memory suitable for mass storage in the example template database 210 and/or the example server reference database 210.

The peripheral I/O controller P22 performs functions that enable the processor P12 to communicate with peripheral input/output (I/O) devices P26 and P28 and a network interface P30 via a peripheral I/O bus P32. The I/O devices P26 and P28 may be any desired type of I/O device such as, for example, a keyboard, a display (e.g., a liquid crystal display (LCD), a cathode ray tube (CRT) display, etc.), a navigation device (e.g., a mouse, a trackball, a capacitive touch pad, a joystick, etc.), etc. The network interface P30 may be, for example, an Ethernet device, an asynchronous transfer mode (ATM) device, an 802.11 device, a DSL modem, a cable modem, a cellular modem, etc. that enables the processor system P10 to communicate with another processor system.

While the memory controller P20 and the I/O controller P22 are depicted in FIG. 10 as separate functional blocks within the chipset P18, the functions performed by these blocks may be integrated within a single semiconductor circuit or may be implemented using two or more separate integrated circuits.

At least some of the above described example methods and/or apparatus are implemented by one or more software and/or firmware programs running on a computer processor. However, dedicated hardware implementations including, but not limited to, application specific integrated circuits, programmable logic arrays and other hardware devices can likewise be constructed to implement some or all of the example methods and/or apparatus described herein, either in whole or in part. Furthermore, alternative software implementations including, but not limited to, distributed processing or component/object distributed processing, parallel processing, or virtual machine processing can also be constructed to implement the example methods and/or systems described herein.

It should also be noted that the example software and/or firmware implementations described herein are stored on a tangible storage medium, such as: a magnetic medium (e.g., a magnetic disk or tape); a magneto-optical or optical medium such as an optical disk; or a solid state medium such as a memory card or other package that houses one or more read-only (non-volatile) memories, random access memories, or other re-writable (volatile) memories. Accordingly, the example software and/or firmware described herein can be stored on a tangible storage medium such as those described above or successor storage media. To the extent the above specification describes example components and functions with reference to particular standards and protocols, it is understood that the scope of this patent is not limited to such standards and protocols. For instance, each of the standards for internet and other packet-switched network transmission (e.g., Transmission Control Protocol (TCP)/Internet Protocol (IP), User Datagram Protocol (UDP)/IP, HyperText Markup Language (HTML), HyperText Transfer Protocol (HTTP)) represent examples of the current state of the art. Such standards are periodically superseded by faster or more efficient equivalents having the same general functionality. Accordingly, replacement standards and protocols having the same functions are equivalents which are contemplated by this patent and are intended to be included within the scope of the accompanying claims.

Additionally, although this patent discloses example methods and apparatus including software or firmware executed on hardware, it should be noted that such systems are merely illustrative and should not be considered as limiting. For example, it is contemplated that any or all of these hardware and software components could be embodied exclusively in hardware, exclusively in software, exclusively in firmware or in some combination of hardware, firmware and/or software. Accordingly, while the above specification described example methods, systems, and machine-accessible medium, the examples are not the only way to implement such systems, methods and machine-accessible medium. Therefore, although certain example methods, systems, and machine-accessible medium have been described herein, the scope of coverage of this patent is not limited thereto. On the contrary, this patent covers all methods, systems, and machine-accessible medium fairly falling within the scope of the appended claims either literally or under the doctrine of equivalents.

1. A method to display process data, the method comprising:
receiving a request to view process data via a web browser;
identifying a server that stores the process data, wherein the server receives the process data from a process control system;
retrieving the process data from the server;
selecting an Extensible Stylesheet Language Transformation (XSLT) template based on a property of the process data; and
generating a display file conforming to a web browsing format based on the XSLT template, the property, and the process data, wherein the display file specifies how the process data is to be displayed via the web browser.

2. A method as defined in claim 1, wherein generating the display file includes:
combining the XSLT template with the process data; and
converting the combined XSLT template and the process data into the web browsing format.

3. A method as defined in claim 2, wherein combining the XSLT template with the process data includes:
identifying a parameter within the XSLT template;
identifying portions of the process data that correspond to the parameter; and
referencing the parameter to the corresponding portions of the process data.

4. A method as defined in claim 3, wherein referencing the parameter includes embedding the portion of the process data into the corresponding parameter.

5. A method as defined in claim 1, further comprising:
rendering the display file based on the property of the process data; and
transmitting the display file to the web browser.

6. A method as defined in claim 1, wherein the web browsing format conforms to a Hyper Text Markup Language (HTML).

7. A method as defined in claim 1, further comprising:
selecting the XSLT template based on a type of a device that transmitted the request; and
generating the display file to conform to a display area of the device.

8. A method as defined in claim 1, further comprising sending an instruction to the web browser that causes a client display application to access and display the display file.

9. A method as defined in claim 1, wherein selecting the XSLT template includes:
selecting an Extensible Markup Language (XML) template based on the property; and
converting the XML template to the XSLT template.

10. A method as defined in claim 1, wherein the XSLT template is generated based on an Electronic Device Description Language (EDDL) file that defines how the process data is to be displayed.

11. An apparatus to display process data, the apparatus comprising:
an adaptor to:
identify a server that stores requested process data, wherein the server receives the process data from a process control system; and
access the process data from the server;
a data processor to select a template based on a property of the process data; and
a web-based interface to generate a display file conforming to a web browsing format based on the template, the property, and the process data, wherein the display file specifies how the process data is to be displayed via a client application.

12. An apparatus as defined in claim 11, wherein the web-based interface is to generate the display file by:
combining the template with the process data; and
converting the combined template and the process data to a format associated with the client application.

13. An apparatus as defined in claim 12, wherein the web-based interface is to combine the template with the process data by:
identifying a parameter within the template;
identifying portions of the process data that correspond to the parameter; and
referencing the parameter to the corresponding portions of the process data.

14. An apparatus as defined in claim 13, wherein the web-based interface is to reference the parameter by embedding the portion of the process data into the parameter.

15. An apparatus as defined in claim 11, wherein the web-based interface is to:
render the display file based on the property of the process data; and
transmit the display file to the client application.

16. An apparatus as defined in claim 11, wherein the web-based interface is to receive a request to view process data from the client application.

17. An apparatus as defined in claim 11, wherein:
the data processor is to select the template based on a type of a device that transmitted the request; and
the web-based interface is to generate the display file to conform to a display area of the device based on the selected template.

18. An apparatus as defined in claim 11, wherein the web-based interface is to send an instruction to the client application that causes the client application to access and display the display file.

19. An apparatus as defined in claim 11, wherein the data processor is to select the XSLT template by:
selecting an Extensible Markup Language (XML) template based on the property; and
converting the XML template to an Extensible Stylesheet Language Transformation (XSLT) template.

20. An apparatus as defined in claim 11, wherein the data processor is to generate the template from an Electronic Device Description Language (EDDL) file that describes how the process data is to be displayed.

21. A machine-accessible medium having instructions stored thereon that, when executed, cause a machine to at least:
receive a request to view process data via a web browser;
identify a server that stores the process data, wherein the server receives the process data from a process control system, wherein the server is associated with an interoperability data packing format;
retrieve the process data from the server;
select an Extensible Stylesheet Language Transformation (XSLT) template based on a property of the process data; and
generate a display file conforming to a web browsing format based on the XSLT template, the property, and the process data, wherein the display file specifies how the process data is to be displayed via the web browser.

22-24. (canceled)
